(19) United States
(12) Patent Application Publication
(10) Pub. No.: US 2020/0005110 A1
(43) Pub. Date: Jan. 2, 2020

(54) HIGH-FIELD EMISSION TOLERANT RFID TAGS ATTACHED TO PRODUCTS TO CONTROL COOKING PROCESS

(71) Applicant: AVERY DENNISON RETAIL INFORMATION SERVICES, LLC, Mentor, OH (US)

(72) Inventor: Ian J. FORSTER, Chelmsford (GB)

(21) Appl. No.: 16/454,792

(22) Filed: Jun. 27, 2019

Related U.S. Application Data
(60) Provisional application No. 62/690,712, filed on Jun. 27, 2018.

(51) Int. Cl. G06K 19/07; G06K 7/10

(52) U.S. Cl. CPC G06K 19/0725; G06K 7/10415

(57) ABSTRACT

A microwave tolerant RFID tag is disclosed that does not need to be removed from a product, such as a food item, before thawing, heating, reheating or cooking the product in a microwave oven, but that can provide data to control the microwave process. The microwave tolerant RFID tag comprises at least one antenna designed to operate at one or more frequencies and an RFID chip carrying data related to the process the microwave oven is required to perform. The data on the RFID chip is read by an RFID reader system to authorize the cooking process of the product.

### CROSS REFERENCE TO RELATED APPLICATION(S)

The present application claims priority to and the benefit of United States provisional utility patent application No. 62/690,712 filed Jun. 27, 2018, which is incorporated herein by reference in its entirety.

### BACKGROUND

The present invention relates generally to a radio-frequency identification (“RFID”) tag that can withstand high-field emissions such as from a microwave, and a method of using the RFID tag to control aspects of a heating process. Specifically, the RFID tags do not need to be removed from a product before cooking or heating in an apparatus such as, but not limited to a microwave. The high-field emission tolerant RFID tags of the present invention may be placed inside an apparatus, such as a microwave oven for a given duration without damaging the product or food item, and the RFID tag can be read or interrogated by a RFID reader system before the high-powered microwave emission starts.

Although other RFID technologies can be used and are contemplated by the present invention, the disclosure focuses on high frequency (“HF”) technology, operating at 13.56 MHz, and ultra-high frequency (“UHF”) technology, operating at various bands worldwide including 865-868 MHz in Europe and 902-928 MHz in the United States. Accordingly, the present specification makes specific reference thereto. However, it is to be appreciated that aspects of the present inventive subject matter are also equally amenable to other like applications and frequencies.

Generally stated, radio-frequency identification or RFID is the use of electromagnetic energy to stimulate a responsive device (known as a RFID “tag” or transponder) to identify itself and, in some cases, provide additionally stored data in the tag. RFID tags typically include a semiconductor device commonly called the “chip” on which are formed a memory and operating circuitry, which is connected to at least one antenna. It is contemplated that the chip may be connected to the at least one antenna either via direct attach or through the utilization of a strap, coupling pads, interposer or any means known in the art. Typically, RFID tags act as transponders, providing information stored in the chip memory in response to a radio frequency interrogation signal received from a reader, also referred to as an interrogator. In the case of passive RFID devices, the energy of the interrogation signal also provides the necessary energy to operate the RFID device.

RFID tags may be incorporated into or attached to articles to be tracked. In some cases, the tag may be attached to the outside of an article with adhesive, tape, or other means and in other cases, the tag may be inserted within the article, such as being included in the packaging, located within the container of the article, or sewn into a garment. The RFID tags are manufactured with a unique identification number which is typically a simple serial number of a few bytes with a check digit attached. This identification number is incorporated into the tag during manufacture. The user cannot alter this serial/identification number and manufacturers guarantee that each serial number is used only once. Such read-only RFID tags typically are permanently attached to an article to be tracked and, once attached, the serial number of the tag is associated with its host article in a computer data base.

Currently, RFID technology implemented in food items to be cooked in a microwave oven cannot survive the high-field emissions of a microwave oven. More specifically, the RFID tag is typically destroyed in the microwave oven cavity, and may also damage the food item to which the RFID tag is attached. Therefore, microwave tolerant RFID tag devices that can function when subjected to high-field emissions such as those in a microwave and that do not damage the food item to which the RFID tag is attached are needed.

The present invention discloses a microwave tolerant RFID tag that does not need to be removed from a product, such as a food item, before cooking or heating in a microwave, but that can provide data to control or alter the cooking process. The RFID tag can be placed inside a microwave oven for a given duration without damaging the food item to which the RFID tag is attached, and may also provide data for controlling, altering and/or automating the cooking process.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a microwave tolerant RFID tag device that is secured to an item to be placed in a microwave field, such as food item, to be thawed, heated, reheated or cooked in a microwave oven. The RFID tag device comprises at least one antenna designed to operate at one or more frequencies, and an RFID chip carrying data related to the product to which it is attached and/or the microwave process (e.g., cooking) that the microwave oven is required to perform. In a preferred embodiment of the present invention, the antenna of the RFID tag device is designed to prevent a destructive arc when placed in a high-level 2.45 GHz field, and minimizes heating of the RFID tag itself during the microwave process.

In another embodiment, a RFID reader system is coupled into the microwave oven cavity to be able to read the RFID tag data before the high-level 2.45 GHz field is applied, as the high-field is likely to destroy the RFID tag device. The RFID reader system may operate at 2.45 GHz and share or be co-located with the oven emitter, or operate at a separate frequency such as UHF in the range of 900 MHz to 930 MHz, or can operate at both frequencies. The RFID reader system then interfaces with the oven controller to authorize and/or control the cooking process of the tagged food item.

While the discussion contained herein primarily references food items placed into a microwave oven for purposes of cooking, thawing, heating or reheating said food item, it should be appreciated that the present invention is not limited to use with food items. More specifically, the present invention has application in any other setting or process in which it is desirable to attach an RFID tag to an article to be placed in or near a microwave oven or field, such as in a manufacturing process.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a top perspective view of a microwave tolerant RFID tag in accordance with the disclosed architecture.

FIG. 2 illustrates a front perspective view of a microwave oven with RFID tag interaction in accordance with the disclosed architecture.

FIG. 3 illustrates a block diagram of an RFID tag interfacing with an oven controller via a reader system in accordance with the disclosed architecture.

FIG. 4 illustrates a front perspective view of a microwaveable RFID tag interacting with an external hotspot reader in accordance with the disclosed architecture.

FIG. 5 illustrates a front perspective view of a microwave using reader antenna for HF RFID tags external to the main microwave cavity in accordance with the disclosed architecture.

FIG. 6 illustrates a front perspective view of a product being rotated within the microwave cavity to ensure an RFID read before cooking in accordance with the disclosed architecture.

FIG. 7 illustrates a block diagram of a method of using data on the product from the RFID tag to activate different authorization levels in accordance with the disclosed architecture.

FIG. 8 illustrates a block diagram of a method of selecting cooking parameters from the RFID tag based on sensor data in accordance with the disclosed architecture.

FIG. 9 illustrates a block diagram of a method of accessing cooking instructions from a web service based on the RFID data in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a RFID tag that is tolerant to high-field emissions or high frequencies such as that from a microwave and that does not need to be removed from a product, such as a food item, before cooking, thawing, heating or reheating in a device such as a microwave oven, and that can provide data to control the cooking/microwave process. The RFID tag comprises at least one antenna designed to operate at one or more specified frequencies and an RFID chip carrying data related to the product to which the RFID is attached and/or the process that the microwave oven is required to perform. The data on the RFID chip is read by an RFID reader system to authorize and/or control the heating process, for example, to cook, heat, reheat or thaw a food item. While the present invention discusses throughout that the heating process is a microwave process, the present invention is not limited to such.

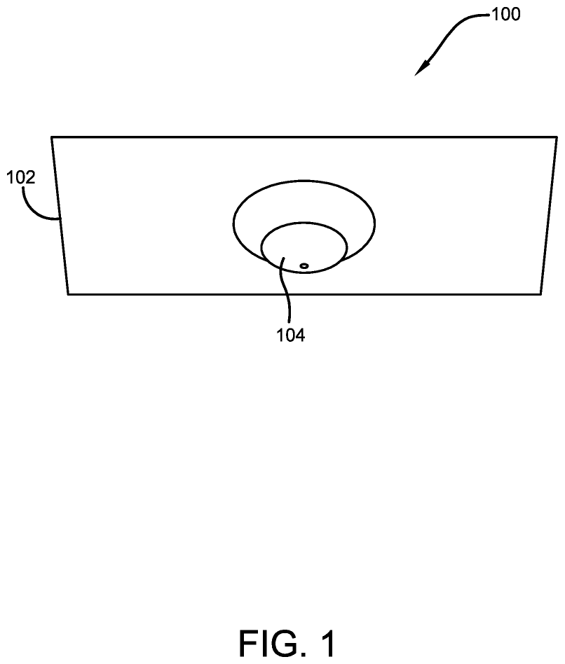

Referring initially to the drawings, FIG. 1 illustrates a RFID tag 100 that is tolerant of high-field emissions such as from a microwave and is designed to be placed inside an apparatus such as an oven and/or microwave, for a predetermined duration of time without damaging the item the RFID tag 100 is attached to, such as a food item. The RFID tag 100 can be a single mode tag or a dual mode tag, and comprises a HF core component which communicates with a HF reader system and/or a UHF core component which communicates with a UHF reader system. The predetermined duration of time is in part or wholly dependent on the power of the heating apparatus (microwave oven) and the nature of the item being defrosted, heated or cooked etc. For example, defrosting may require extended times, in the order of 10-30 minutes, at low power, heating chilled food to the temperature to eat it may use high power (defined as being between 700W and 2000W) for a short period, between 30 seconds and 2 minutes, and cooking may requires a range of times and powers related to the product, for example two (2) minutes for a high protein, low mass items such as eggs or seafood, and up to 30 minutes for a high density items such as a joint of meat or very dense vegetables such as potatoes.

Typically, the RFID tag 100 can be any suitable size, shape, and configuration as is known in the art without affecting the overall concept of the invention. One of ordinary skill in the art will appreciate that the size, shape and configuration of the RFID tag 100 as shown in FIG. 1 is for illustrative purposes only and many other sizes, shapes and configurations of the RFID tag 100 are well within the scope of the present disclosure. Although dimensions of the RFID tag 100 (i.e., length, width, and height) are important design parameters for good performance, the RFID tag 100 may be any shape or size that ensures optimal performance during use.

The RFID tag 100 comprises at least one antenna 102, which is designed to operate at one or more frequencies depending on the needs and/or wants of a user. The RFID tag 100 can also have a plurality of antennas. For instance, in one embodiment, the RFID tag 100 has a secondary antenna, or can communicate with a secondary antenna in the cavity. Typically, antenna 102 is metallic, but can be manufactured of any suitable material as is known in the art. The antenna 102 is also designed to prevent a destructive arc when placed in a high-level field, such as 2.45 GHz, or any other suitable high-level range. Generally stated, prevention of the arc reduces the amount of energy applied to the RFID tag 100, and minimizes the heating of the RFID tag 100 during the microwave process as well. Accordingly, the RFID tag 100 can be read or otherwise communicated with before the high power microwave emission starts at a suitable frequency, for example UHF via at least one additional or secondary antenna in the cavity, or possibly simply at 2.45 GHz so the existing antenna can be shared.

The set of operational frequencies can include, but are not limited to, SHF, for example 2.45 GHz, UHF, commonly for RFID in the band 800-1000 MHz and/or HF at 13.56 MHz. The required operational frequencies may be determined, in one embodiment, from the functions required at various points in the supply chain or needs of the users; for example. for inventory control, a UHF frequency is commonly chosen, due to the long range capability; for short range interaction with a mobile device a HF frequency, 13.56 MHz may be used; for operation inside the microwave prior to the main cooking power being turned on, 2.45 GHz may be used. benefiting from the fact that an antenna for reading the tags is already in the cavity. It will be appreciated that in some cases, two or more frequencies may be chosen; for example, an RFID tag equipped with both an HF antenna for consumer interaction via a mobile device and UHF for functions such as logistics, inventory and auto checkout may be desirable.

Additionally, as shown in FIG. 1, the RFID tag 100 comprises an RFID chip 104, which may carry data related to the RFID tag 100, the item to which RFID tag 100 is attached, and/or the process the microwave oven is required or intended to perform. Specifically, data received from the RFID chip 104 may include, but is not limited to, a unique identifier for the RFID tag 100, product identification, product “use by” data, product “consume by” date, allergen information, cooking parameters for the food, instructions such as heat, stir, and dwell time after heating, etc.

For example, with respect to expired product “use by” or “consume by” dates, the RFID chip 104 could be used to prevent the microwave from operating to thaw, cook, heat or reheat the food without a manual override, thereby preventing the user from unknowingly consuming food that is no longer fit for consumption and preventing illness. This feature is particularly useful when, for example, the printed on information containing the product “use by” or “consume by” dates is no longer readable by the human eye, or gets separated from the food product.

Additionally, the needed authorization to override the RFID chip 104 could be different for different food products and/or for different users. For example, the override needed for foods for infants, seafood, or foods with particular known allergens (e.g., foods that have peanuts) could be considered high risk and could require a specific password, rather than a simple yes/no or verbal confirmation. Further, this particular product data can also be combined with data about the user, such as allergen information, to preventing cooking actions, sound an alarm, ask for verbal confirmation, etc. Further, the RFID chip 104 can also be associated with a sensor that can detect whether the food product is thawed, chilled or frozen, and information or output from the sensor could, in turn, be used to modify the cooking parameters appropriately without further user interaction. For example, for frozen food products, the sensor output could be used to instruct the microwave oven to first thaw the food product at one microwave power setting, and then cook the food product at a different power setting. Alternatively, if the food product is determined by the sensor to already be thawed, the sensor output may be used to instruct the microwave oven to bypass the thaw process and proceed straight to the cooking process, thereby saving both time and the energy necessary to operate the microwave oven during the thaw process.

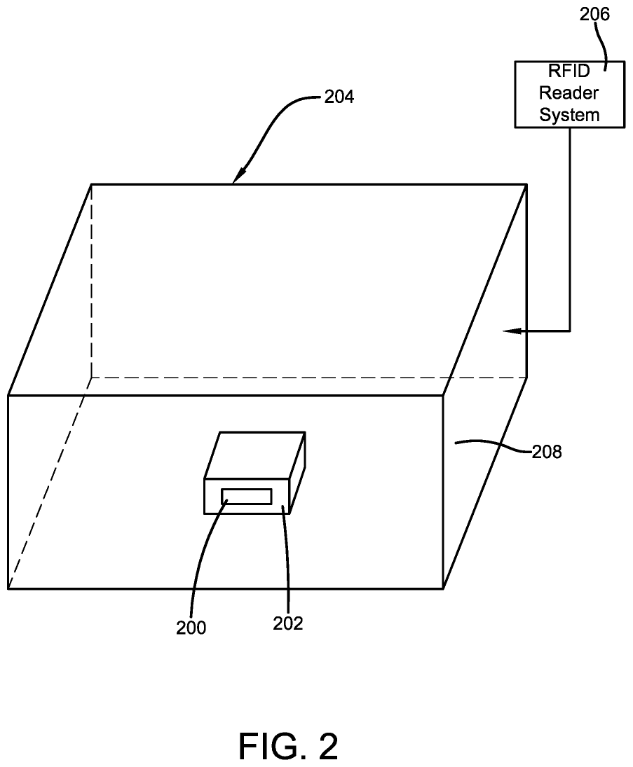

In another embodiment of the present invention shown in FIG. 2, the RFID tagged item or product 202 is placed inside an apparatus 204 such as a microwave oven. Specifically, the high-field tolerant RFID tag 200 is secured to an item, such as, but not limited to food (RFID tagged product 202) to be thawed, heated, reheated or cooked. The RFID tag 200 is secured to the product 202 via any suitable securing means as is known in the art, such as gluing. The present invention contemplates that the RFID tag 200 is secured to the product 200 via an adhesive approved for food use (ie GRAS adhesive), etc. The tagged product 202 is then placed inside the cavity 208 such as in a microwave oven. A RFID reader system 206 is coupled into the cavity 208 to be able to read the RFID tag data before the high-level 2.45 GHz field is applied, as the high-field is likely to destroy the RFID tag device 200. The RFID reader system 206 may operate at 2.45 GHz and share or be co-located with the oven emitter, or operate at a separate frequency such as UHF in the range of 900 MHz to 930 MHz, or can operate at both frequencies. Operating at both frequencies allows the RFID reader system 206 to be co-located with the microwave oven emitter and to read or interrogate RFID tags 200 outside of the microwave as well. Specifically, operating at 2.45 GHz may be the best approach for in the microwave oven reading, and operating at UHF may be best for inventory operations before the product is sold.

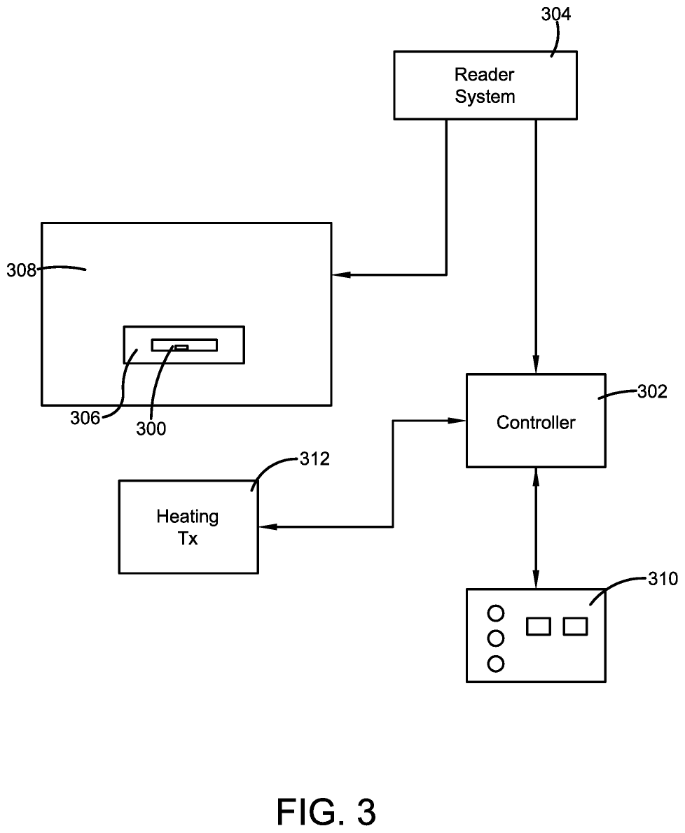

FIG. 3 illustrates one possible embodiment of a reader system process wherein the high-level tolerant RFID tag 300 interfaces with the controller 302 of the apparatus via the RFID reader system 304. Specifically, the microwave tolerant RFID tag 300 is secured to a food item or other RFID tagged product 306 to be thawed, heated, reheated or cooked by the apparatus 204. The tagged product 306 is then placed inside the microwave cavity 308, and a RFID reader system 304 is coupled into the microwave oven cavity 308 to be able to read the RFID tag data before the high-level 2.45 GHz field is applied.

Thus, the RFID reader system 304 accesses data from the RFID tag 300, and then interfaces with the oven controller 302 and the consumer interface 310 and the heating transmission control 312 to allow it to use the correct thawing, heating, reheating and/or cooking process. Specifically, data received from the RFID tag 300 may include a unique identity, product identifier, “use by” or “consume by” data, or inclusion of allergen information (e.g., about peanuts), which may be combined with data related to a particular user, such as items that particular user may be allergic to. In such event, the data may be used to sound an alarm to notify the user of the issue, or prevent the further operation of the microwave oven without manual override.

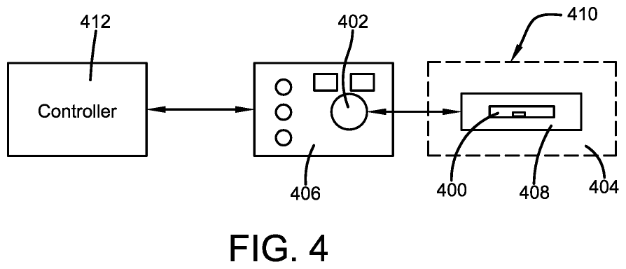

FIG. 4 shows an alternate configuration of the present invention. In this configuration, the RFID reader system 402 is external to the cavity 404, for example, as part of the control panel 406, thereby allowing RFID tagged product or food items 408 to be read before being placed in the heating apparatus 410 such as a microwave oven. Specifically, the high tolerant RFID tag 400 is secured to the food item or product 408 to be thawed, heated, reheated or cooked, and the tagged product 408 is then placed inside the heating apparatus cavity 404. The RFID reader system 402 becomes a hotspot reader, and is coupled to the control panel 406, external to the microwave cavity 404. Thus, the RFID reader system 402 accesses data from the RFID tag 400, and then interfaces with the oven controller 412 and the control panel 406 to allow it to use the correct cooking process. Thus, specific data and/or operating instructions such as unique identity, product identifier, “use by” or “consume by” data, or inclusion of allergens, such as peanuts, seafood, etc., may be read from the RFID tag 400 before the RFID tagged product 408 is placed in the microwave oven 410.

Further, as with the other configurations/embodiments discussed supra and infra, data received from the RFID tag 400 or a related sensor about the food products or the particular user of the oven (e.g., the user's allergens, etc.) may be used to sound an alarm to notify the user of an issue or conflict, or prevent the further operation of the microwave oven without manual override. The manual override could be a simple “yes” or “no” input or verbal command by the user for minor issues or conflicts, or could require a specific password for more serious matters, such as peanut allergies or when the food item or product 408 is to be consumed by or used in relation to an infant.

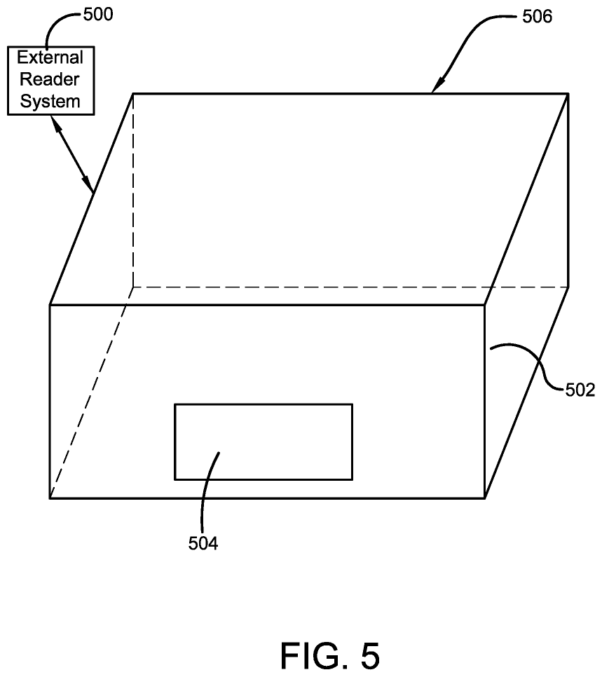

Additionally, as shown in FIG. 5, an external reader system 500 reads RFID tags inside a cavity 502 such as a cavity of a microwave oven. Specifically, the high-emission tolerant RFID tag is secured to a food item or other product to be thawed, heated, reheated or cooked. The tagged product is then placed inside the microwave oven cavity 502. The RFID reader system 500 is secured external to the microwave cavity 502, and comprises an antenna 504 which operates to read HF RFID tags within the microwave cavity 502. The microwave cavity 502 is shielded at 2.45 GHz to prevent radio frequency leakage. However, the microwave oven 506 only requires shielding to prevent levels of 2.45 GHz emission that might interfere with systems such as wireless (i.e., Wi-Fi) or that might injure a user, and said shielding can be frequency selective. For example, the shielding may block frequencies lower than 2.45 GHz, such as 500 MHz, and may block frequencies higher than 2.45 GHz, such as 5 GHz, but may not block low frequencies, such as 13.56 MHz which may be used to read HF RFID tags. Thus, a HF reader system 500 can be placed external to the microwave cavity 502, for example around the door, and can read RFID tags on the food items or other RFID tagged products within the microwave cavity 502. Thus, the RFID reader system 500 accesses data from the RFID tag, and then interfaces with the oven controller to allow it to use the correct cooking parameters, such as power, duration of microwave process and the appropriate microwave function (e.g., thawing, heating, reheating, cooking, etc.). Thus, specific data and instructions such as unique identity of the RFID tag, product identifier, “use by” data or “consume by” data, or inclusion of allergens, such as peanuts, can be read from the RFID tag on the food item while it is within the microwave cavity 502 and the appropriate adjustment made.

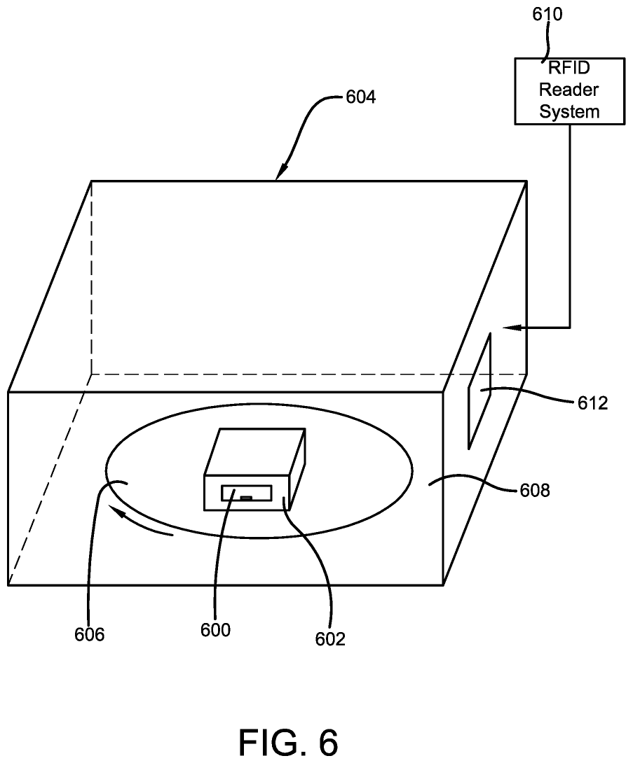

FIG. 6 shows a method of increasing the read rate of RFID tags 600 attached to products 602 before the microwave oven 604 is activated when a turntable 606 is used. Thus, the RFID tagged product 602 is rotated on the turntable 606 to ensure an RFID read by the reader system 610 prior to being thawed, heated, reheated or cooked. Specifically, the microwave tolerant RFID tag 600 is secured to the food item or product 602 to be heated or cooked, and the tagged product 602 is then placed inside the microwave oven cavity 608 on the turntable 606. The RFID reader system 610 is coupled to the microwave oven emitter 612 to access data from the RFID tag 600 to allow it to use the correct cooking process. However, before turning on the microwave field, the turntable 606 rotates (in a counterclockwise or clockwise duration) to increase the probability that the RFID tags' path to the RFID reader system 610 is not blocked by the product 602 or that the product 602 is in a null position due to the arrangement of the metal walls of the microwave during rotation of the turntable 606. Thus, specific date and/or instructions, such as unique identity, product identifier, “use by” or “consume by” data, or inclusion of allergens, such as peanuts, can be read from the RFID tag 600 while the RFID tagged product 602 is within the microwave oven 604 and the appropriate adjustment made.

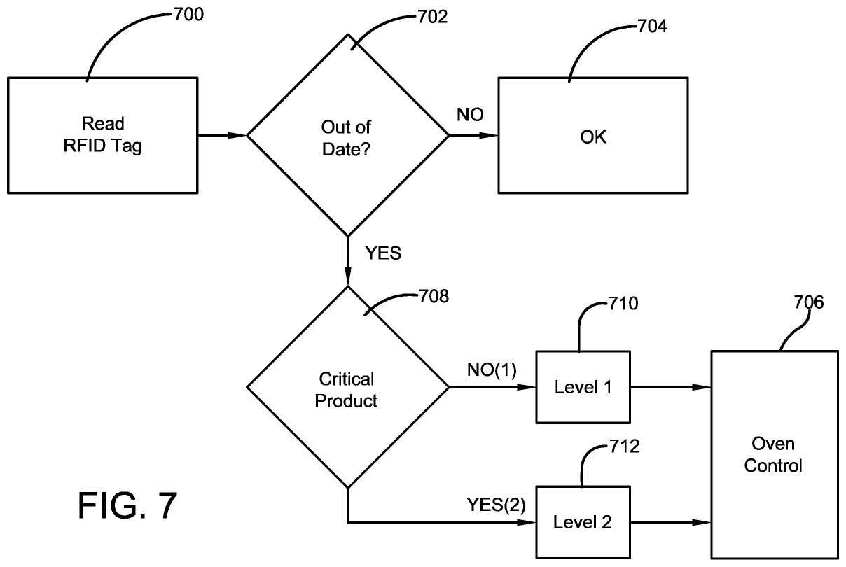

FIG. 7 illustrates but one of many possible examples of how “use by” or “consume by” data on a RFID tagged product can be combined with other data, either from the manufacturer or relating to a particular user, to activate different cooking parameters, authorization levels necessary to override a cooking parameter, etc. Data relating to the user can include, but is not limited to, information regarding allergic reactions, time of day when cooking, age of the user, etc. This data, along with the manufacturer data and/or product data, acts to control if a particular microwave operation (e.g., thawing, heating, reheating, cooking, etc.) is authorized and, in the event it is not directly authorized, it requires further action from the user. Said further action by a user can include entering a password, using a RFID card, using a near field communication (NFC) enabled phone, etc., or any other suitable action as is known in the art for taking action.

More specifically, the process begins at 700 wherein the RFID tag on the RFID tagged product is read or interrogated and data concerning the RFID tagged product is collected and analyzed. At 700, the RFID tag may be read or interrogated either inside or outside of the microwave cavity, depending on the particular RFID reader system being utilized. At 702, it is determined if the data read from the RFID tag shows that the tagged product is out of date (i.e., beyond its “best if used by” or “consume by” date). If the product is not out of date, then at 704 the process continues and at 706 the microwave oven control panel controls the appropriate microwave function (e.g., thawing, heating, reheating or cooking) on the RFID tagged product. If the product is out of date then, at 708, it is determined if the product is a critical product. Whether a product is a “critical product” can be defined by any number of user specified parameters. For example, “critical products” could include baby products, products that tend to cause food poisoning if out of date, etc. If the product is not a critical product, then at 710 the process moves to level one and would then proceed directly to the desired microwave function (i.e., thawing, heating, reheating, cooking, etc.) and, at 706, the microwave oven control panel controls the desired microwave function.

For example, if the RFID tagged product is beyond its “best before date” (i.e., is out of date), but is not a critical product (e.g., based on a low probability of food poisoning), for example, vegetables, the microwave oven would proceed at 706 directly to the desired microwave function. This may occur with or without other parameters from the RFID tag, such as cooking instructions. If, on the other hand, the product is both out of date and a critical product then, at 712, the process moves to level two. For example, if the product was to fall into a critical product category, for example shellfish or baby food, the microwave oven would require further authorization to override the lock out, such as a password. The same process could apply to products of food items containing allergens. If a user had previously defined that a person with an allergy to, for example, peanuts might be using the microwave oven, any products presented to the microwave oven containing peanuts would require a high-level over-ride (e.g., a password) and possibly sound an alarm.

Another aspect could relate to the age of the user. For example, a product that indicates that it becomes very hot during cooking, such as those containing high-levels of sugar syrup, would require an over-ride if children were present in the house to prevent the child from overheating the food product and suffering burning or scalding from the same. After further authorization occurs, the process then proceeds directly to the desired microwave function (e.g., cooking, thawing, heating, reheating, etc.), and at 706 the microwave oven control panel controls the microwave process on the RFID tagged product. As previously discussed, differing levels of authorization could be established depending on the critical nature of the issue and/or the particular needs of the user.

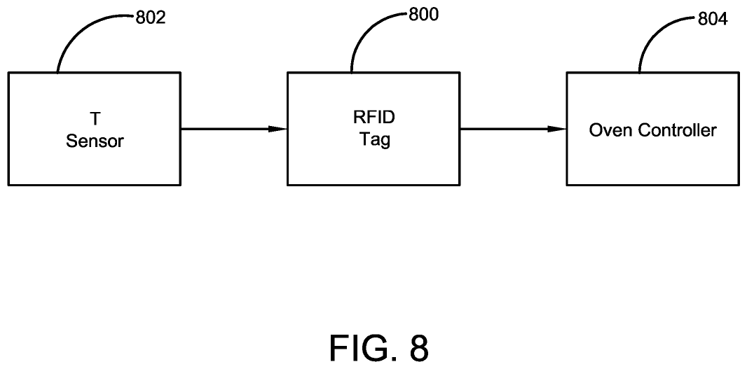

FIG. 8 illustrates yet another embodiment wherein the RFID tag 800 comprises some form of sensor 802. For example, sensor 802 can be a temperature sensor that can indicate if the RFID tagged product is thawed, chilled or frozen, or any other sensor as is known in the art, such as a moisture sensor, etc. Based on the sensor state and RFID data, the microwave oven can then select an appropriate cooking method (i.e., based on whether the food item is, for example, already thawed, chilled or frozen) as determined by the oven controller 804 which then utilizes the data read from the RFID tagged product to select the appropriate microwave function to be performed.

For example, for frozen food products, the output from sensor 802 could be used to instruct the microwave oven controller 804 to first thaw the food product at one microwave power setting, and then cook the food product at a different power setting. Alternatively, if the food product is determined by sensor 802 to already be thawed, the sensor output may be used to instruct the microwave oven controller 804 to bypass the thaw process, and proceed straight to the cooking process, thereby saving both time and the energy necessary to operate the microwave oven during the thaw process, which is not necessary in this particular application.

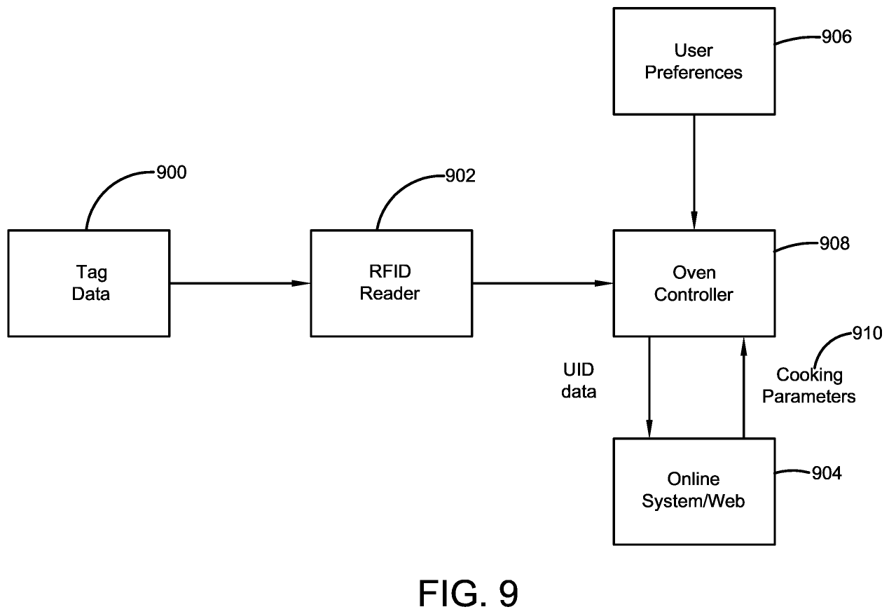

FIG. 9 illustrates a further embodiment of the present invention wherein the tag data 900 obtained by the RFID reader system 902 triggers a look up from an online web service 904 or external database for the correct cooking parameter for that specific food item. Specifically, the oven controller 908 sends user interface data to the online system/web service 904 or external database to obtain additional information about the food item and how to prepare the same. For example, the web service 904 can provide additional information regarding the food item, such as tips on how to best cook the food item in the microwave, the appropriate power setting to use, or whether the food item is better cooked thawed, chilled or frozen, etc. The cooking parameters 910 can then be combined with user preferences 906 for some food items, for example, preferences such as the state of how the meat should be prepared, or the desired softness of vegetables, bread, etc. The oven controller 908 then utilizes both the cooking parameters 910 from the web service 904 or other external database along with the user preferences 906 to control the microwave cooking process of the food item.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A radio-frequency identification (RFID) tag that can withstand high-field emissions comprising:
a RFID chip; and
at least one antenna, wherein the at least one antenna prevents a destructive arc when the RFID tag is placed in a high-level field.

2. The RFID tag of claim 1, wherein the RFID tag contains data related to at least one of: (i) a product to which the RFID tag is attached; and (ii) a microwave oven.

3. The RFID tag of claim 1, wherein the RFID tag is in communication with a RFID reader system.

4. The RFID tag of claim 1, wherein the RFID tag comprises a HF core component which communicates with a HF reader system.

5. The RFID tag of claim 1, wherein the RFID tag comprises a UHF core component which communicates with a UHF reader system.

6. The RFID tag of claim 1, wherein the high-level microwave field is approximately 2.45 GHz.

7. The RFID tag of claim 1 further comprising a second antenna.

8. The RFID tag of claim 1, wherein the RFID tag is in communication with a sensor.

9. A radio-frequency identification (RFID) system comprising:
a RFID tag comprised of a RFID chip and at least one antenna;
a RFID reader system; and
a heating apparatus such that the least one antenna prevents an arc when the RFID tag is placed within the apparatus.

10. The RFID system of claim 9, wherein the apparatus emits a high-level microwave field after the RFID reader system interrogates the RFID tag.

11. The RFID system of claim 9, wherein RFID chip contains information that can be used to change a set of operating parameters of the microwave oven.

12. The RFID system of claim 9 further comprising a sensor.

13. The RFID system of claim 9, wherein the RFID tag further comprises a second antenna.

14. The RFID system of claim 9, wherein RFID tag is attached to a product and contains information about the product, and further wherein said information is used to control the microwave oven.

15. A method of utilizing a high-field emission tolerant radio-frequency identification (RFID) tag have stored data thereon and comprising:
securing the RFID tag to an item;
placing the RFID tag and the item inside an apparatus;
utilizing a RFID reader system to read the stored data from the RFID tag;
receiving the stored data from the RFID tag; and
using the RFID reader system to communicate with a controller of the apparatus.

16. The method of utilizing a high-field emission tolerant RFID tag of claim 15 further comprising the step of:
utilizing the stored data from the RFID tag to authorize or modify a microwave process on the item.

17. The method of utilizing a high-field emission tolerant RFID tag of claim 15, wherein the RFID reader system receives the stored data from the RFID tag before a field is applied by the controller.

18. The method of utilizing a high-field emission tolerant RFID tag of claim 15, wherein the RFID reader system is external to the apparatus and reads the stored data from the RFID tag before the item is placed inside the apparatus.

19. The method of utilizing a high-field emission tolerant RFID tag of claim 15 further comprising the steps of:
activating a turntable within the apparatus during the reading of the stored data; and
communicating with an external information source.
